(19) United States
(12) Patent Application Publication
(10) Pub. No.: US 2024/0429599 A1
(43) Pub. Date: Dec. 26, 2024

(54) CALIBRATION METHOD AND SYSTEM FOR PHASED ARRAY ANTENNA

(71) Applicant: ELECTRONICS AND TELECOMMUNICATIONS RESEARCH INSTITUTE, Daejeon (KR)

(72) Inventors: Jun Han LIM, Daejeon (KR); Hong Yeol LEE, Sejong-si (KR); Jin Cheol JEONG, Daejeon (KR); Dong Pil CHANG, Daejeon (KR)

(73) Assignee: ELECTRONICS AND TELECOMMUNICATIONS RESEARCH INSTITUTE, Daejeon (KR)

(21) Appl. No.: 18/750,150

(22) Filed: Jun. 21, 2024

(30) Foreign Application Priority Data
Jun. 22, 2023 (KR) 10-2023-0080153

(51) Int. Cl. H01Q 3/26; H04B 17/12; H04B 17/21

(52) U.S. Cl. CPC H01Q 3/267; H04B 17/12; H04B 17/221

(57) ABSTRACT

A calibration system of a phased array antenna is disclosed, including an antenna device comprising the phased array antenna, a measurement device configured to measure outputted signals from each radiating element arrayed in the phased array antenna to generate measured value data, and an analysis device configured to analyze the measured value data to generate and transmit analysis data to the antenna device, wherein the antenna device is configured to determine a phase offset to be applied to each radiating element based on the analysis data.

### CROSS-REFERENCE TO RELATED APPLICATIONS

This application is based on, and claims priority from, Korean Patent Application Number 10-2023-0080153, filed Jun. 22, 2023, the disclosure of which is incorporated by reference herein in its entirety.

### TECHNICAL FIELD

The present disclosure in some embodiments relates to a calibration method and calibration system of a phased array antenna.

### BACKGROUND

The statements in this section merely provide background information related to the present disclosure and do not necessarily constitute prior art.

FIG. 1 is a schematic diagram of a phased array antenna.

A phased array antenna is an antenna that varies the radiation direction or directivity by varying the magnitudes and phases of the signals between its radiating elements (E). The phased array antenna includes multi-function chips (MFCs) connected with an array of the radiating elements (E). The radiating elements (E) in the array and the multi-function chips (MFCs) may be connected 1:1 as shown in FIG. 1, but are not limited thereto, and may be implemented as n radiating elements (E) connected with one multi-function chip (MFC) or n radiating elements (E) connected with m multi-function chips (MFC), depending on the number of channels or design of the phased array antenna. The multi-function chip (MFC) controls several radio frequency (RF) functions, such as phase shifting, attenuation, and amplification of the connected radiating elements (E). Phased array antennas are widely used in 5^{th} generation (5G) networks or satellite communications (SATCOM), for example, because they can achieve a sharper beam pattern and higher gain compared to using single antennas.

However, since a phased array antenna uses multiple radiating elements (E), a calibration process is required to match the signal magnitude or phase of each radiating element (E) to a reference value.

Korean Registered Patent No. 10-2241805 (hereinafter referred to as “prior art 1”) relates to an automatic calibration method and an automatic calibration device for calibrating a gain and a phase deviation between sub-arrays of an active phased array antenna. Korean Patent Application Publication No. 10-2021-0089900 (hereinafter referred to as “prior art 2”) relates to a phase calibration apparatus for a phased array antenna, which applies a plurality of phase sets and implements phase calibration based on a phase difference with respect to each of a plurality of RF chains through signal transmission and reception.

In prior art 1, the calibration is achieved by employing a representative gain and a representative phase for each sub-array and comparative preset values of the reference representative gain and reference representative phase. Prior art 2 sets an arbitrary reference phase value for each of the plurality of RF chains and uses a phase difference between the RF chains as a basis for achieving the phase calibration.

The calibration methods of prior art 1 and 2 set a reference value for a specific radiating element (E) to achieve calibration of the remaining radiating elements (E), which requires repeated calibration of the radiating elements (E) at the initial setting of the antenna or when changing the radiation pattern.

Furthermore, they suffer from difficulties in their calculation of a definite control value due to the difference in assemblability between the respective radiating elements (E) and the antenna module and the nonlinearity of the antenna module.

### SUMMARY

The present disclosure provides a calibration method and system that eliminates the need for calibration through repeated output measurements of radiators by determining an optimal phase offset to be applied to all radiators based on actual measurement values of individual radiators.

The present disclosure provides a calibration method and system that can calculate clear control values that take into account assembly differences between each radiator and antenna module and nonlinearities of the antenna module by applying a lookup table-based control value matching in which the characteristics of the multifunctional chip are stored.

According to at least one embodiment, the present disclosure provides a calibration system of a phased array antenna, including an antenna device comprising the phased array antenna, a measurement device configured to measure outputted signals from respective radiating elements arrayed in the phased array antenna to generate measured value data, and an analysis device configured to analyze the measured value data to generate and transmit analysis data to the antenna device, wherein the antenna device is configured to determine a phase offset to be applied to each radiating element based on the analysis data.

The antenna device may include radio frequency (RF) modules each including a radiating element and including a multi-function chip (MFC) configured to control an RF function of the radiating element, a control module configured to control the RF module, and a terminal module configured to be in communication with the measurement device, the analysis device, and the control module to transmit a control signal.

The RF function may be a combination of any one or more of RF input and output, phase shifting, attenuation, and low-noise amplification of the radiating element.

The antenna device may be configured to store a look-up table (LUT) that is measured characteristics of the multi-function chips

The look-up table may include error information for each of control values for gains and phases, obtained in all bands, of a radiating element linked with a particular multi-function chip.

The look-up table may include control value information that has the least error at the radiating element's particular gain or particular phase to be changed.

The measurement device may include a probe module positioned proximate the front surface of the radiating element and configured to measure an outputted signal of the radiating element, a displacement module connected to the probe module and configured to move the probe module toward the front surface of the radiating element, and a driving module configured to provide a driving force to the displacement module and to operate in accordance with a control signal from the antenna device.

The analysis device may be configured to extract S-parameter information for the outputted signals of the radiating elements and to transmit the S-parameter information upon request of the antenna device.

The S-parameter information may be the S-parameter for all phases of the radiating element.

The phase offset may be applied based on a phase with the least error for all radiating elements included in the phased array antenna.

According to another embodiment, the present disclosure provides a calibration method for a phased array antenna, the calibration method including a first step of driving a measurement device by an antenna device to position a probe module proximate the front surface of each of the radiating elements, a second step of supplying radio frequency (RF) power by the antenna device to each of the radiating elements, a third step of analyzing, by an analysis device, an outputted signal of each of the radiating elements, which is measured by the probe module, a fourth step of transmitting information obtained by the analyzing by the analysis device to the antenna device, and determining a phase offset to be applied to each radiating element based on measured values of all radiating elements obtained by iteration of the first step through the fourth step.

The calibration method may further include generating a look-up table (LUT) that is measured characteristics of a multi-function chip (MFC).

The look-up table may include error information for each of the control values for gains and phases, obtained in all bands, of a radiating element linked with a particular multi-function chip.

The look-up table may include control value information that has the least error at the radiating element's particular gain or phase to be changed.

The second step may include disconnecting RF power from other radiating elements than the relevant radiating element or lowering the gain of the other radiating elements to the minimum.

The analysis device in the second step may be configured to extract S-parameter information for outputted signals of the radiating elements and to transmit the S-parameter information upon request of the antenna device

The S-parameter information may be S-parameters according to all phase states of the radiating element.

The phase offset may be applied based on a phase with the least error for all radiating elements included in the phased array antenna.

According to yet another embodiment, the present disclosure provides a calibration system of a phased array antenna, including an antenna device comprising the phased array antenna, a measurement device configured to measure outputted signals from respective radiating elements arrayed in the phased array antenna to generate measured value data, and an analysis device configured to analyze the measured value data to generate and transmit analysis data to the antenna device, wherein the antenna device comprises multi-function chips (MFCs) each configured to control a radio frequency (RF) function of each of the radiating elements, wherein the antenna device is configured to pre-store a look-up table (LUT) that is measured characteristics of the multi-function chips, and wherein the antenna device is configured to determine a phase offset to be applied to each radiating element based on the analysis data and a reference value of the look-up table (LUT).

The antenna device may include a radio frequency (RF) module including a radiating element, and including multi-function chips (MFCs) each configured to control an RF function of the radiating element, a control module configured to control the RF module, and a terminal module configured to be in communication with the measurement device, the analysis device, and the control module to transmit a control signal.

The look-up table (LUT) may store reference values for all control bits of the multi-function chips according to a desired phase and attenuation with no radiating element connected.

The look-up table may include control value information that has the least error at the radiating element's particular gain or particular phase to be changed.

The measurement device may include a probe module positioned proximate to the front surface of the radiating element and configured to measure an outputted signal of the radiating element, a displacement module connected to the probe module and configured to move the probe module toward the front surface of the radiating element, and a driving module configured to provide a driving force to the displacement module and to operate in accordance with a control signal from the antenna device.

The analysis device may be configured to extract S-parameter information for the outputted signals of the radiating elements and to transmit the S-parameter information upon request of the antenna device.

The S-parameter information may be S-parameters according to all phases of the radiating element.

The phase offset may be determined as an optimal control bit by combining a phase bit control value based on the S-parameter information with a size bit reference value based on the look-up table (LUT).

According to yet another embodiment, the present disclosure provides a calibration method for a phased array antenna, the calibration method including a fifth step of storing a look-up table (LUT) by measuring characteristics of multi-function chips (MFCs) included in an antenna device, a sixth step of driving a measurement device by the antenna device to position a probe module proximate a front surface of each of radiating elements, a seventh step of supplying radio frequency (RF) power by the antenna device to each of the radiating elements, an eighth step of analyzing, by an analysis device, an outputted signal of each of the radiating elements, which is measured by the probe module, a ninth step of transmitting information obtained by the analyzing by the analysis device to the antenna device, and determining a phase offset to be applied to each radiating element based on a reference value of the look-up table (LUT), which is obtained in the fifth step and measured values of the radiating elements obtained by iteration of the sixth step through the ninth step.

The look-up table (LUT) stored by the fifth step may be generated with reference values for all control bits of the multi-function chips according to a desired phase and attenuation with no radiating element connected.

The look-up table (LUT) stored by the fifth process may include control value information that has the least error at the radiating element's particular gain or particular phase to be changed.

The seventh step may include disconnecting RF power from other radiating elements than the relevant radiating element or lowering the gain of the other radiating elements to the minimum.

The analysis device in the eighth step may be configured to extract S-parameter information for outputted signals of the radiating elements and to transmit the S-parameter information upon request of the antenna device.

The S-parameter information may be S-parameters according to all phase states of the radiating element.

The phase offset may be determined as an optimal control bit by combining a phase bit control value based on the S-parameter information with a size bit reference value based on the look-up table (LUT).

### BRIEF DESCRIPTION OF THE DRAWINGS

FIG. 1 is a schematic diagram of a phased array antenna.

FIG. 2 is a block diagram of a calibration system according to at least one embodiment of the present disclosure.

FIG. 3 is a flowchart of a calibration method according to at least one embodiment of the present disclosure.

FIG. 4 is a flowchart of a calibration method according to another embodiment of the present disclosure.

FIG. 5A is a graph depicting the phase states of a phased array antenna before calibration.

FIG. 5B is a graph depicting the phase states of the phased array antenna after calibration.

FIG. 6 is a graph of a measured and interpreted beam pattern of the phased array antenna after calibration.

FIG. 7 is a graph of measurements by each beam tilting scenario of the phased array antenna after calibration.

### DETAILED DESCRIPTION

Hereinafter, various embodiments of the present disclosure are described in detail with reference to the accompanying drawings. In the following description, like reference numerals refer to like elements even though the elements are shown in different drawings. Further, in the following description of the embodiments, a detailed description of known functions and configurations incorporated therein have been omitted for the purpose of clarity and for brevity.

In addition, terms such as first, second, A, B, (a), (b) may be used to describe components of the present disclosure. These terms are intended only to distinguish one component from another, and the nature, sequence, or order of the components is not limited by the terms. Throughout the specification, whenever any part is said to “include” or “comprise” any component, it is meant to be inclusive of other components, not exclusive of other components, unless specifically stated to the contrary. In addition, terms such as “˜part,” “module,” and the like in the specification refer to a unit that handles at least one function or operation, which may be implemented in hardware or software or a combination of hardware and software. When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer readable media, as part of the apparatus.

The following detailed description, together with the accompanying drawings, is intended to illustrate exemplary embodiments of the present disclosure and is not intended to represent the only embodiments in which the present disclosure may be practiced.

The present disclosure seeks to provide a calibration method and system that eliminates the need for calibration by repeatedly measuring the output of radiating elements by determining an optimal phase offset to be applied to all radiating elements based on measured values of individual radiating elements and proceeding with calibration.

The present disclosure further seeks to provide a calibration method and system in which, by applying a control value matching based on a look-up table storing the characteristics of multi-function chips, a definite control value can be calculated taking into account the difference in assemblability between the respective radiating elements and the antenna module and the nonlinearity of the antenna module.

The objects of the present disclosure are not limited to those particularly described hereinabove, and the above and other objects that the present disclosure could achieve will be clearly understood by those skilled in the art from the following detailed description.

Hereinafter, some embodiments of the present disclosure will be described in detail with reference to the accompanying drawings. In the following description, like reference numerals preferably designate like elements, although the elements are shown in different drawings. Further, the following description of some embodiments will omit for the purpose of clarity and for brevity, a detailed description of related known components and functions when considered obscuring the subject of the present disclosure.

Various ordinal numbers or alpha codes such as first, second, i), ii), a), b), etc., are prefixed solely to differentiate one component from the other but not to imply or suggest the substances, order, or sequence of the components. Throughout this specification, when a part “includes” or “comprises” a component, the part is meant to further include other components, to not exclude thereof unless specifically stated to the contrary.

The description of the present disclosure to be presented below in conjunction with the accompanying drawings is intended to describe exemplary embodiments of the present disclosure and is not intended to represent the only embodiments in which the technical idea of the present disclosure may be practiced.

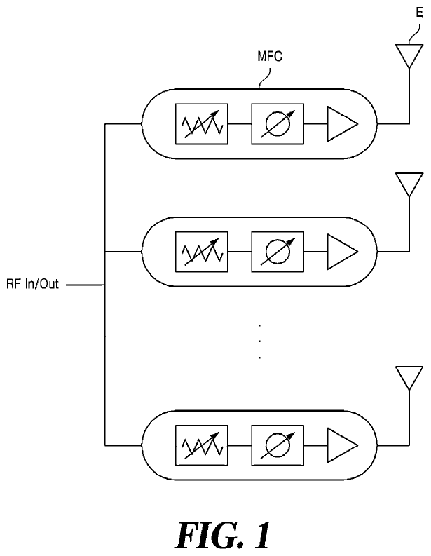

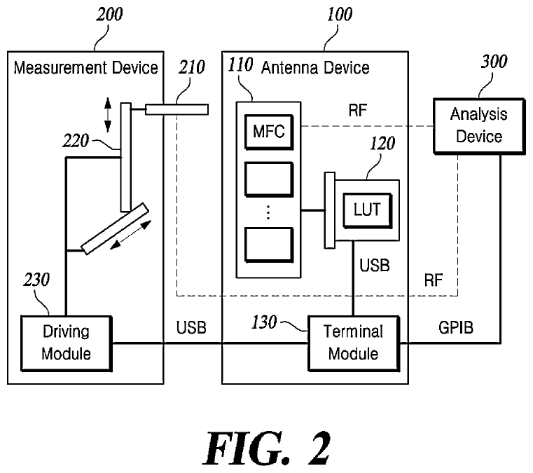

FIG. 1 is a schematic diagram of a phased array antenna, and FIG. 2 is a block diagram of a calibration system according to at least one embodiment of the present disclosure.

Referring to FIGS. 1 and 2, the calibration system of the phased array antenna according to some embodiments includes an antenna device 100, a measurement device 200, and an analysis device 300.

The antenna device 100 includes an RF module 110, a control module 120, and a terminal module 130.

The RF module 110 includes N (N is a natural number) radiating elements E, and includes N′ (N′ is a natural number, less than N) multi-function chips (MFCs) for controlling RF functions for the signals of the radiating elements E. The radiating elements E and the MFCs may be connected 1:1 to form single RF transceiver modules as shown in FIG. 1, but are not limited thereto. Since there may be multiple channels in one MFC, the radiating elements E and the MFCs may be connected in the form of N:1 or N:N′. The RF module 110 is composed of a set of RF transceiver modules.

Each multi-function chip (MFC) includes components for modifying and controlling RF characteristics of a radiating element E, such as an attenuator, a phase shifter, and an amplifier.

The control module 120 controls the RF module 110, including a processor embedded with a plurality of control algorithms. The control module 120 controls RF functions of the radiating elements E, such as phase shifting and low-noise amplification. The control module 120 transmits MFC control signals to the RF module 110 to implement gain changes and phase changes of the corresponding radiating elements E.

The terminal module 130 transmits control signals to the control module 120 and is connected with the measurement device 200 and the analysis device 300 to receive measured and analyzed data from the respective devices.

The control module 120 stores a look-up table LUT that is measured characteristics of the multi-function chips (MFCs).

The look-up table LUT includes error information for each of the control values for the gains and phases obtained in all bands of the radiating element E linked to a particular MFC. Alternatively, the look-up table LUT may store reference values for all control bits of the MFC according to the desired phase and attenuation with no radiating element E connected. This means that the look-up table LUT may be control value-specific error information (first type) obtained by measuring the characteristics of the MFCs linked with the radiating elements E, or the look-up table LUT may be reference values (second type) obtained by measuring the characteristics of the MFCs with no radiating elements E connected. The first type of look-up table LUT may be applied when an initial calibration is performed by determining an analysis data-based phase offset and thereafter further calibration is required. The second type of look-up table LUT may be applied when a phase offset is determined based on analysis data and reference values. Commonly to the first and second types, a look-up table LUT may include information on the control value with the least error for the radiating element E's particular gain or particular phase to be changed.

The look-up table LUT is stored internally in the control module 120 and includes characteristic information of all multi-function chips (MFCs) included in the RF module 110. When the terminal module 130 needs to control the MFCs e.g., when needing to adjust the gain or phase in the first type, it can easily find the control value corresponding to the desired adjustment value by referring to the look-up table LUT.

The measurement device 200 serves to measure an outputted signal for each of the radiating elements E included in the phased array antenna. The measurement device 200 includes a probe module 210, a displacement module 220, and a driving module 230.

The probe module 210 is positioned proximate to the front surface of the radiating element E to be measured so that it can measure the outputted signal of the radiating element. The displacement module 220 is configured to move the probe module 210 to the front surface of the radiating element E by a driving force of the driving module 230. The driving module 230 provides a driving force to the displacement module 220 and operates according to a control signal transmitted by the terminal module 130. When the terminal module 130 sends a control signal for moving the probe module 210 to the driving module 230, the driving module 230 applies a driving force to the displacement module 220 to displace the probe module 210 in the up, down, left, and right directions.

The analysis device 300 serves to generate analysis data by analyzing the measured value data of the radiating elements E measured and generated by the measurement device 200 and to transmit the analysis data to the antenna device 100 upon request of the terminal module 130.

The analysis device 300 is connected to and communicates with the terminal module 130 by a General Purpose Interface Bus (GPIB). The analysis device 300 receives the measured value data of the radiating elements E by RF communication with the RF module 110 and the probe module 210.

The terminal module 130 is in a USB-serial connection with the control module 120 to implement control-signal communication to and from the respective radiating elements E and MFCs. The terminal module 130 is in a USB-serial connection with the driving module 230 to implement position-control-signal communication to and from the probe module 210.

More specifically, the analysis device 300 analyzes and generates S-parameter information for the radiating element E's outputted signal measured by the probe module 210. The analysis device 300 transmits the extracted S-parameter information upon request of the terminal module 130. The S-parameter information is the S-parameters for all phase states of the radiating elements E.

The S-parameter information is utilized as base data for determining a phase offset for calibration of the respective radiating elements E. The terminal module 130 stores the S-parameters at all phases of all radiating elements E.

The S-parameters according to at least one embodiment of the present disclosure may be utilized as independent analysis data to determine the phase offset to be applied to each radiating element E. Preferably, the phase offset may be determined based on the phase with the least error for all radiating elements. In this case, the look-up table LUT may be utilized in the first type described above for further calibration of the phased array antenna.

The S-parameter according to another embodiment of the present disclosure may be utilized as auxiliary analysis data and combined with the already measured look-up table LUT reference values (in the second type) to determine a phase offset to be applied to each radiating element E. Preferably, the phase offset may be determined as an optimal control bit by combining the phase bit control value based on the S-parameter information with the size bit reference value based on the look-up table LUT. In this case, the look-up table LUT is utilized in the second type described above.

Since the present disclosure adopts a method of performing calibration of all radiating elements based on measured values (S-parameters) at all phases of individual radiating elements E constituting the phased array antenna, a repeating calibration based on setting certain radiating element phases to reference values and analyzing signals with the remaining radiating elements is unnecessary.

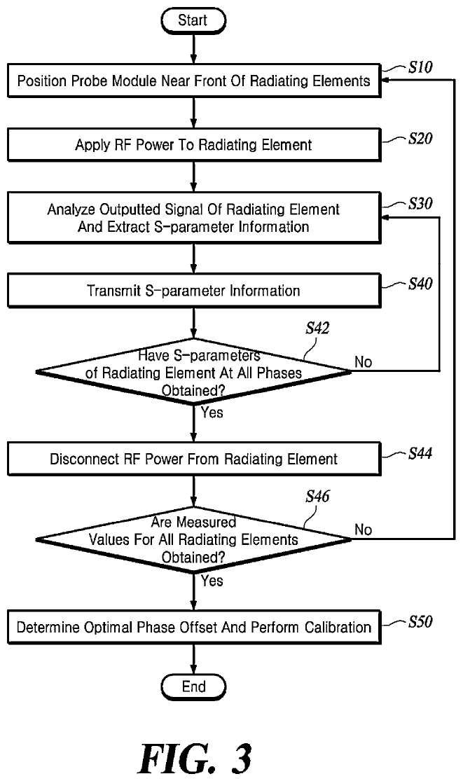

FIG. 3 is a flowchart of a calibration method according to at least one embodiment of the present disclosure.

The driving module 230 receives a control signal for moving the probe module 210 transmitted by the antenna device 100 and drives the displacement module 220 to position the probe module 210 near the front of the radiating element E to be measured (S10).

The antenna device 100 supplies RF power to the radiating element E to be measured (S20). Step S20 may be a process of disconnecting the supply of RF power from the other radiating elements than the radiating element E to be measured, or of lowering the gain of the other radiating elements to the minimum.

The analysis device 300 receives and analyzes the outputted signal from the radiating element E, which is measured by the probe module 210 (S30). The analysis device 300 analyzes the received signal to extract S-parameter information of the radiating element E. The analysis device 300 analyzes the received signal. The S-parameter information is the S-parameters according to all phase states of the radiating element E.

At the request of the antenna device 100, the analysis device 300 transmits the information analyzed and extracted by the analysis device 300 to the antenna device 100 (S40).

The terminal module 130 of the antenna device 100 determines whether it has obtained the S-parameters at all received phases of the radiating element E (S42). If the S-parameter acquisition is not completed, the method returns to Step S30 and requests the S-parameter information for the next phase control bit. On the other hand, if the S-parameters are completely obtained, the RF power is disconnected from the current radiating element E (S44).

The terminal module 130 of the antenna device 100 determines whether the measurement and storage of measured values for all arrayed radiating elements is complete (S46). If the measurement and storage of the measured values of all the radiating elements are determined to be incomplete, the method returns to Step S10 and performs the measurement process for the next radiating element E.

When the measurement and storage of the measured values of all radiating elements are determined to be complete, the terminal module 130 determines the optimal phase offset to be calibrated based on the obtained measured values of the radiating elements E and performs the calibration (S50). The phase offset may be applied based on the phase with the least error for all radiating elements E included in the phased array antenna. Specifically, the phase offset may be determined as an initial phase of one or more radiating elements E, or it may be determined as a specific phase that is calibrated by phase control of all radiating elements E.

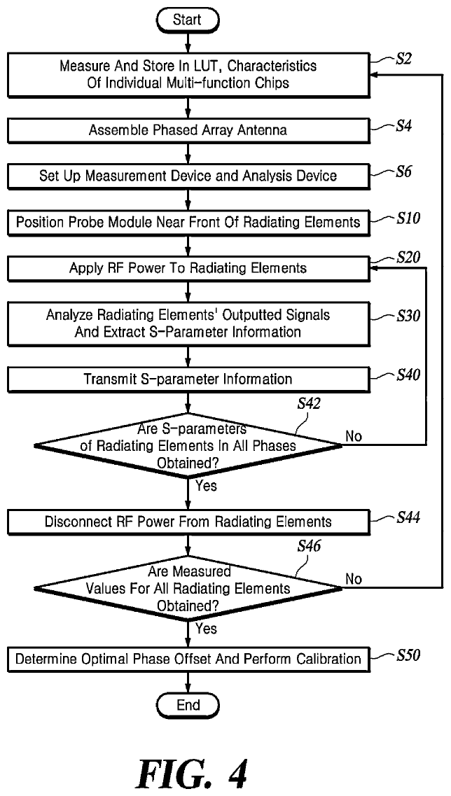

FIG. 4 is a flowchart of a calibration method according to another embodiment of the present disclosure.

According to the present disclosure, the calibration method of a phased array antenna may also include the following steps to further enhance the calibration function (LUT, first type) or to provide base data for determining the phase offset (LUT, second type).

In addition to determining the phase offset based on measured values of the radiating elements E, the further step may be a step (LUT, first type) to facilitate finding the optimal control value when the gain of each radiating element E needs to be adjusted, and a step (LUT, second type) to determine the phase offset by combining the analysis data based on the measured values and the reference value based on the look-up table LUT.

The calibration method of a phased array antenna according to the present disclosure further includes a step (S2) of generating a look-up table LUT that is measured characteristics of the MFCs.

The look-up table LUT includes error information for each of control values for the gains and phases obtained in all bands of the radiating element E linked to a particular MFC. Alternatively, the look-up table LUT may store reference values for all control bits of the MFC according to the desired phase and attenuation with no radiating element E connected. This means that the look-up table LUT may be control value-specific error information (first type) obtained by measuring the characteristics of the MFCs linked with the radiating elements E, or the look-up table LUT may be reference values (second type) obtained by measuring the characteristics of the MFCs with no radiating elements E connected. The first type of look-up table LUT may be applied when an initial calibration is performed by determining an analysis data-based phase offset and thereafter further calibration is required. The second type of look-up table LUT may be applied when a phase offset is determined based on analysis data and reference values. Commonly to the first and second types, a look-up table LUT may include information on the control value with the least error for the radiating element E's particular gain or particular phase to be changed.

In the first type, the look-up table LUT is written to record the MFC characteristics of the multi-function chips MFCs with the radiating elements E and the MFCs connected, and in the second type, the look-up table LUT is written to record the MFC characteristics of the multi-function chips MFCs without the connections of the radiating elements E and the MFCs. After the look-up table LUT is written up, the antenna device 100 is configured (S4).

Then, the measurement device 200 and the analysis device 300 connected to the antenna device 100 are set up (S6), and Steps S10 to S50 described with reference to FIG. 3 are sequentially performed for calibration.

The following details the operation process of the calibration system and method of the phased array antenna.

### Applying First Type Look-Up Table LUT

When the terminal module 130 transmits to the driving module 230 a control signal for moving the probe module 210, the driving module 230 applies a driving force to the displacement module 220 to displace the probe module 210 in the up, down, left, and right directions. When a trigger signal indicating that the movement of the probe module 210 has been completed is inputted to the terminal module 130, the probe module 210 waits at that position until the next movement control signal is received.

The antenna device 100 supplies RF power exclusively to the current radiating element E to be measured. If the exclusive supply of RF power to a single radiating element E is not available, the method controls to lower the gain of the radiating elements not being measured to be the minimum.

The probe module 210 performs measurements on all rated control bits of the phase shifter of the MFC associated with the measured radiating element E. For example, if the phase shifter operates at 6-bit, the probe module 210 measures the outputted signal vectors according to 64 phase states and transmits the measurements to the analysis device 300. The analysis device 300 analyzes the received measurement signal to extract S-parameter information for the outputted signal of the current radiating element E and stores the S-parameter information in memory. The analysis device 300 transmits the stored S-parameter information to the terminal module 130 upon request of the terminal module 130. Then, when the terminal module 130 determines that it has completed receiving the information normally, it requests the S-parameter information for the next phase control bit and performs this process for every phase state of the current radiating element E. The terminal module 130 of the antenna device 100 stores all the S-parameter information within the range that can be controlled, and then transmits a measurement completion trigger signal for the current radiating element to the measurement device 200.

The terminal module 130 of the antenna device 100 transmits a trigger signal to the measurement device 200 to move the probe module 210 to the position of the radiating element E to be measured next and repeats the signal measurement step after the movement of the probe module 210 is completed. The terminal module 130 repeats the aforementioned steps to obtain and store S-parameter information of all radiating elements E.

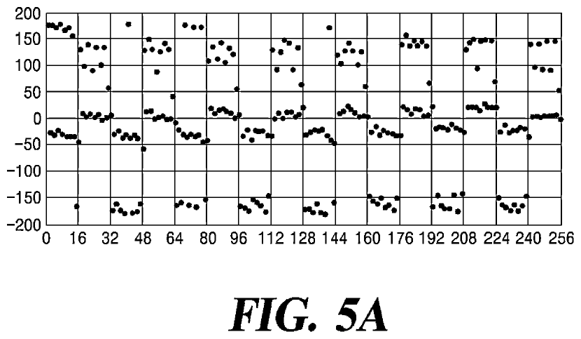

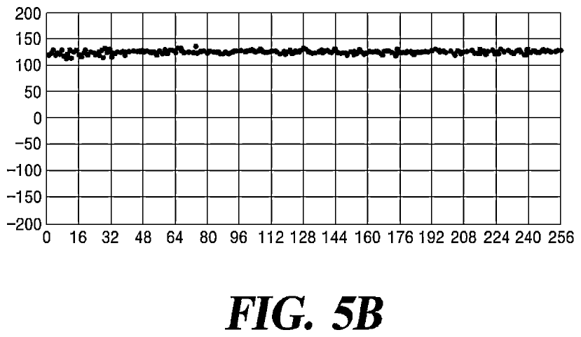

All operations and measurement steps are implemented by high-speed USB serial communication, GPIB, and the like so that information storage is completed in a very short time. For example, if M phase states are measured for a total of N radiating elements, N×M pieces of S2P data may be obtained. Under most circumstances, the time to obtain a single measurement data item is within a few hundred milliseconds. As shown in FIGS. 5A and 5B, a comparison of the phase states before and after calibration confirms the optimized calibration of the calibration system according to the embodiments of the present disclosure.

The calibration system and method according to some embodiments of the present disclosure can easily identify and apply the optimal phase offsets required for the respective radiating elements based on the S2P data which is the measured value data of the radiating elements E.

Especially for initial calibration, where the output phases of all radiating elements E need to be adjusted to the same value within a tolerance, it is easy to determine which phase offset when applied has the least error. The phase offset may be the initial phase of one or more radiating elements, or it may be a specific phase that is calibrated by phase control of all radiating elements.

Furthermore, when it is necessary to calibrate not only the phase but also the gain of each radiating element, the gain can be calibrated by applying the control value with the least error at the desired phase based on a look-up table LUT that stores the results of the MFC characteristic measurement.

When calibration is performed based on measured values and a look-up table LUT according to embodiments of the present disclosure, not only the initial calibration can be performed but also the control values of the MFCs required for the actual operation of tilting the beam pattern can be easily calculated. Specifically, the direction of the beam steering in the azimuth and elevation directions determines the requisite phase offset of each component radiating element E of the phased array antenna.

Based on the determined phase offset, the MFC characteristic-specific control value is extracted by referring to the look-up table LUT. By applying the extracted control value to each radiating element E, the antenna device 100 can realize a calibration with the least error while taking into account the phase and gain.

### Applying Second Type of Look-Up Table LUT

For all the control bits of the multi-function chips (MFCs), a characteristic measurement is performed without connecting the radiating elements E, and based on the measurement results, a look-up table LUT is generated and stored according to the desired phase and attenuation.

The step of obtaining the S-parameter information by measuring the output of the radiating element E, such as assembling the antenna device, is as described above and is omitted to avoid redundancy.

When both the output measurement and analysis of the radiating elements E are completed, the antenna device determines the phase offset by deriving the optimal bit as obtained by combining the analysis data based on the radiating element output measurement and the reference value based on the look-up table LUT. For example, the phase offset is determined by controlling the (attenuation 0, phase 0), (attenuation 0, phase 5.625°), . . . , (attenuation 0, phase 354.375°) bits indicated by the look-up table LUT, and then performing measurements (by adding the phase by 5.625° with the attenuation set to 0, for a total of 64 measurements), and the size bit is determined by referring to the look-up table LUT of the multi-function chips that underwent the previous measurements, and combining the two information to derive the optimal bit.

In this case, the application of the determined phase offset has the advantage of simplifying the setup of a single measurement of the MFCs, since it obviates the need for such procedures as moving the probe module probe module when generating a look-up table LUT, greatly reducing the measurement time of the radiating elements E. For example, if there are 256 radiating elements, 5 size bits, and 6 phase bits, the calibration step can be completed with only 256*2\hat{ }6 times of control and measurement if the size bits are utilized by the look-up table LUT reference values of the MFCs over 256*2\hat{ }5*2\hat{ }6 times of control and measurement, which are required if the size bits are performed in the antenna measurement.

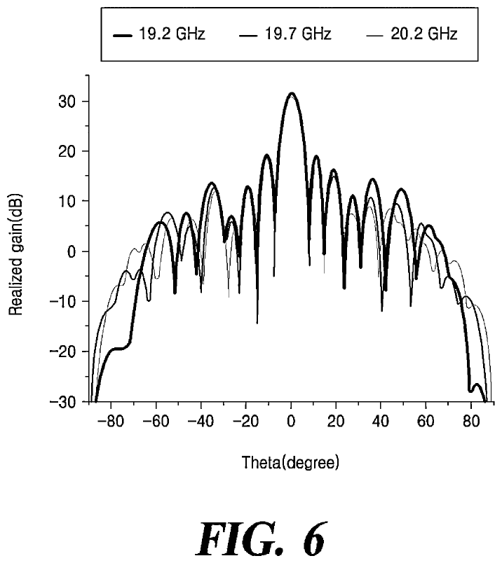

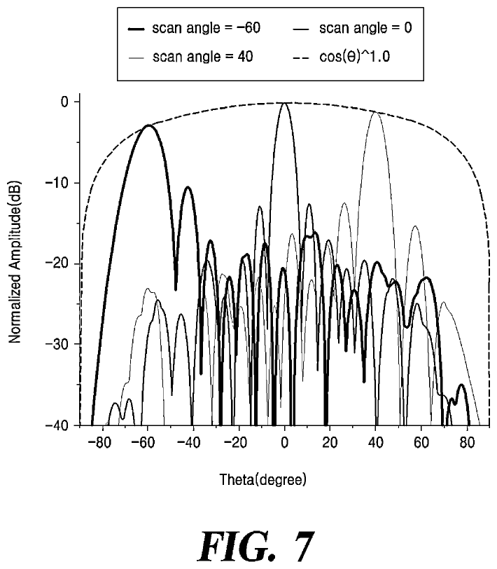

FIG. 6 is a graph of the measured and interpreted beam pattern of the phased array antenna after calibration, and FIG. 7 is a graph of measurements by each beam tilting scenario of the phased array antenna after calibration. FIG. 6 shows the gain by frequency at 0° beam reference after completing the antenna calibration, and FIG. 7 shows the measurement results of beam tilting angle (−60°, 0°, 40°). In FIG. 7, the measurement results for three different beam tilting angles are shown so that the interior of the cos appears to be somewhat empty although there are more beam tilting angles. It should be noted that the number of beam tilting angles is intentionally reduced to improve the visibility of the graph.

The present disclosure enables the calibration of a phased array antenna to be performed in a very short time, and the control values of the MFCs, which are required not only for the initial calibration but also for the actual operation of the beam, can be derived at once without further testing. In this step, the control values are based on measured values, encompassing the assembly status of the antenna, rather than predicted values, resulting in more accurate calibration results with reduced uncertainty compared to the prior art.

The components described in the exemplary embodiments of the present disclosure may be achieved by hardware components including at least one of Digital Signal Processor (DSP), a processor, a controller, an Application Specific Integrated Circuit (ASIC), a programmable logic element such as a Field Programmable Gate Array (FPGA), other electronic devices, and combinations thereof. At least some of the functions or the steps described in the exemplary embodiments of the present disclosure may be achieved by software that may be recorded on a recording medium. At least some of the components, functions, and steps described in the exemplary embodiments of the present disclosure may be achieved by a combination of hardware and software.

The method according to exemplary embodiments of the present disclosure may be written as a program that can be executed in a computer and may be implemented using various recording media, such as magnetic storage media, optical readout media, digital storage media, etc.

Implementations of the various techniques described herein may be implemented as digital electronic circuitry, or as computer hardware, firmware, software, or combinations thereof. Implementations may be implemented as computer program products, i.e., computer programs tangibly embodied in an information carrier, e.g., a machine-readable storage device (computer-readable medium), or a radio signal, for processing by, or controlling the operation of, a data processing device, e.g., a programmable processor, a computer, or a plurality of computers. A computer program, such as the computer program(s) described above, may be written in any form of programming language, including compiled or interpreted languages and may be deployed in any form, including as a stand-alone program or as modules, components, subroutines, or other units suitable for use in a computing environment. The computer program may be deployed to be processed on a computer or computers at a single site, or distributed across multiple sites and interconnected by a communication network.

Processors suitable for processing computer programs include, for example, both general-purpose and special-purpose microprocessors, and any one or more processors of any type of digital computer. Generally, the processor will receive instructions and data from read-only memory or random access memory, or both. Elements of the computer may include at least one processor executing instructions and one or more memory devices storing instructions and data. In general, the computer may include one or more mass storage devices, such as magnetic, magneto-optical, or optical disks, that store data, or may be coupled to receive data from them, transmit data to them, or both. Information carriers suitable for embodying computer program instructions and data include, for example, semiconductor memory devices, e.g., hard disks, magnetic media such as floppy disks and magnetic tapes, optical media such as compact disk read only memory (CD-ROM) and digital video disks (DVDs), magneto-optical media such as floptical disks, read only memory (ROM), random access memory (RAM), flash memory, erasable programmable ROM (EPROM), electrically erasable programmable ROM (EEPROM), and the like. The processor and memory may be supplemented by, or include special-purpose logic circuitry.

The processor may perform an operating system and software applications executed on the operating system. The processor device may also access, store, manipulate, process, and generate data in response to the execution of the software. For ease of understanding, a processor device is sometimes described as utilizing a single processing element, but one of ordinary skill in the art will recognize that a processor device may include a plurality of processing elements and/or a plurality of types of processing elements. For example, a processor device may include a plurality of processors or one processor and one controller. Other processing configurations such as a parallel processor can enter.

Further, the non-transitory computer-readable media may be any available medium that can be accessed by a computer and may include both computer storage media and transmission media.

While this specification includes details of some specific implementations, they should not be understood as limiting the scope of any invention or claimed subject matter, but rather as a description of features that may be peculiar to a particular embodiment of a particular invention. Certain features described herein in the context of individual embodiments may be implemented in combination in a single embodiment. Conversely, various features described in the context of a single embodiment may also be implemented in a plurality of embodiments, either individually or in any suitable sub-combination. Further, while features may operate in a particular combination and be initially described literally as claimed, one or more features of the claimed combination may be excluded from the claimed combination in some instances, and the claimed combination may be changed to a sub-combination or variation of the sub-combination.

Similarly, although the drawings depict operations in a particular order, it should not be understood that such operations must be performed in the particular or sequential order depicted or that all depicted operations must be performed to achieve a desired result. In certain cases, multitasking and parallel processing may be advantageous. Further, the separation of the various device components in the embodiments described above should not be understood to require such separation in all embodiments, and it should be understood that the program components and devices described may generally be integrated into a single software product or packaged in multiple software products.

According to at least one embodiment of the present disclosure, calibration is performed by determining an optimal phase offset to be applied to all radiating elements based on measured values of individual radiating elements, thereby eliminating the need for calibration by repeatedly measuring the output of the radiating elements.

According to at least one embodiment of the present disclosure, by applying a control value matching based on a look-up table storing the characteristics of multi-function chips, a definite control value can be calculated taking into account the difference in assemblability between the respective radiating elements and the antenna module and the nonlinearity of the antenna module.

The effects of the present disclosure are not limited to those mentioned above, and other unmentioned effects will be clearly understood by those skilled in the art from the above description.

On the other hand, the embodiments of the present disclosure presented by the specification and drawings are merely specific examples for clarity and are not intended to limit the scope of the disclosure. It should be clear to those of ordinary skill in the art that besides the embodiments disclosed herein modifications thereto can be made within the scope of the present disclosure.

The scope of protection of the present disclosure is to be construed by the following claims, and all equivalent technical ideas within the scope thereof are to be construed as being included in the scope of the present disclosure.

REFERENCE NUMERALS

| | | | |
|---|---|---|---|
| 100: | antenna device | 110: | RF module |
| 120: | control module | 130: | terminal module |
| MFC: | multi-function chip | LUT: | look-up table |
| 200: | measurement device | 210: | probe module |
| 220: | displacement module | 230: | driving module |
| 300: | analysis device | | |

What is claimed is:

1. A calibration system of a phased array antenna, comprising:
an antenna device comprising the phased array antenna;
a measurement device configured to measure outputted signals from each radiating element arrayed in the phased array antenna and generate measured value data from the outputted signals; and
an analysis device configured to analyze the measured value data to generate and transmit analysis data to the antenna device,
wherein the antenna device is configured to determine a phase offset to be applied to the each radiating element based on the analysis data.

2. The calibration system of claim 1, wherein the antenna device comprises:
a radio frequency (RF) module including the each radiating element, and including a multi-function chip (MFC) configured to control an RF function of the each radiating element;
a control module configured to control the RF module; and
a terminal module configured to be in communication with the measurement device, the analysis device, and the control module to transmit a control signal.

3. The calibration system of claim 2, wherein the antenna device is configured to store characteristics of the multi-function chips in a look-up table (LUT).

4. The calibration system of claim 3, wherein the look-up table includes error information for each of control values for gains and phases, obtained in all bands, of the each radiating element linked with a particular multi-function chip.

5. The calibration system of claim 1, wherein the measurement device comprises:
a probe module positioned proximate a front surface of the each radiating element and configured to measure an outputted signal of the each radiating element;
a displacement module connected to the probe module and configured to move the probe module toward the front surface of the each radiating element; and
a driving module configured to provide a driving force to the displacement module and to operate in accordance with a control signal from the antenna device.

6. The calibration system of claim 5, wherein the analysis device is configured to extract S-parameter information for the outputted signals of the each radiating element and to transmit the S-parameter information upon request of the antenna device.

7. The calibration system of claim 1, wherein the phase offset is applied based on a phase with a least error for the each radiating element included in the phased array antenna.

8. A calibration method for a phased array antenna, the calibration method comprising:
driving a measurement device by an antenna device to position a probe module proximate a front surface of each radiating element, as a first step;
supplying radio frequency (RF) power by the antenna device to the each radiating element, as a second step;
analyzing, by an analysis device, an outputted signal of each of the each radiating element, which is measured by the probe module, as a third step;
transmitting information obtained by the analyzing by the analysis device to the antenna device, as a fourth step; and
determining a phase offset to be applied to the each radiating element based on measured values of all radiating elements obtained by iteration of the first step through the fourth step.

9. The calibration method of claim 8, further comprising:
generating a look-up table (LUT) that is stored characteristics of a multi-function chip (MFC).

10. The calibration method of claim 8, wherein the phase offset is applied based on a phase with a least error for all radiating elements included in the phased array antenna.

11. A calibration system of a phased array antenna, comprising:
an antenna device comprising the phased array antenna;
a measurement device configured to measure outputted signals from each radiating element arrayed in the phased array antenna to generate measured value data; and
an analysis device configured to analyze the measured value data to generate and transmit analysis data to the antenna device,
wherein the antenna device comprises multi-function chips (MFCs) each configured to control a radio frequency (RF) function of each of the each radiating element,
wherein the antenna device is configured to pre-store characteristics of the multi-function chips in a look-up table (LUT), and
wherein the antenna device is configured to determine a phase offset to be applied to the each radiating element based on the analysis data and a reference value of the look-up table (LUT).

12. The calibration system of claim 11, the antenna device comprises:
a radio frequency (RF) module including the each radiating element, and including multi-function chips (MFCs) each configured to control an RF function of the each radiating element;
a control module configured to control the RF module; and
a terminal module configured to be in communication with the measurement device, the analysis device, and the control module to transmit a control signal.

13. The calibration system of claim 11, wherein the look-up table (LUT) stores reference values for all control bits of the multi-function chips according to a desired phase and attenuation with no radiating element connected.

14. The calibration system of claim 11, wherein the measurement device comprises:
a probe module positioned proximate a front surface of the each radiating element and configured to measure an outputted signal of the each radiating element;
a displacement module connected to the probe module and configured to move the probe module toward the front surface of the each radiating element; and
a driving module configured to provide a driving force to the displacement module and to operate in accordance with a control signal from the antenna device.

15. The calibration system of claim 11, wherein the analysis device is configured to extract S-parameter information for the outputted signals of the each radiating element and to transmit the S-parameter information upon request of the antenna device.

16. The calibration system of claim 15, wherein the phase offset is determined as an optimal control bit by combining a phase bit control value based on the S-parameter information with a size bit reference value based on the look-up table (LUT).

17. The calibration method of claim 8, further comprising:
storing a look-up table (LUT) by measuring characteristics of multi-function chips (MFCs) included in an antenna device, as a fifth step;
driving a measurement device by the antenna device to position a probe module proximate a front surface of each radiating element, as a sixth step;
supplying the RF power by the antenna device to the each radiating element, as a seventh step;
analyzing, by an analysis device, an outputted signal of the each radiating element, which is measured by the probe module, as an eighth step;
transmitting information obtained by the analyzing by the analysis device to the antenna device, as a ninth step; and
determining a phase offset to be applied to the each radiating element based on a reference value of the LUT, which is obtained in the fifth step and measured values of the each radiating element obtained by iteration of the sixth step through the ninth step.

18. The calibration method of claim 17, wherein the LUT stored by the fifth step is generated with reference values for all control bits of the multi-function chips according to a desired phase and attenuation with no radiating element connected.

19. The calibration method of claim 17, wherein the analysis device in the eighth step is configured to extract S-parameter information for outputted signals of the each radiating element and to transmit the S-parameter information upon request of the antenna device.

20. The calibration method of claim 19, wherein the phase offset is determined as an optimal control bit by combining a phase bit control value based on the S-parameter information with a size bit reference value based on the LUT.
